(19) United States
(12) Patent Application Publication
(10) Pub. No.: US 2010/0170536 A1
(43) Pub. Date: Jul. 8, 2010

(54) HIGH PRESSURE WATER CLEANING SYSTEM WITH RECYCLED WASTE WATER

(76) Inventors: Tim D. Heinonen, Linden, MI (US); Steven G. Thomas, South Lyon, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/350,272

(22) Filed: Jan. 8, 2009

(51) Int. Cl. B08B 7/04; A47L 7/00

(52) U.S. Cl. 134/10; 15/320

(57) ABSTRACT

A system for removing material from a surface includes a platform mounting a spinning water jet. A high pressure pump delivers water at a high pressure to the spin water jet. The high pressure pump receives water from a fresh water tank. A vacuum is applied within the platform to remove waste water and material back onto a vehicle frame, and into a vacuum tank. The vacuum tank is provided with filters to screen removed materials from the waste water. The waste water then being returned to the fresh water tank for reuse.

### BACKGROUND OF THE INVENTION

This application relates to a mobile high pressure water cleaning system, such as is known for cleaning highways or runways, wherein a vacuum pulls waste water back upwardly onto a vehicle, and the waste water is cleaned and recycled as pump water.

High pressure water cleaning systems are known, and may include a movable platform carrying water jets that moves along a surface to be cleaned, such as a runway or highway. Typically, a pump delivers extremely high pressure water to the surface. As an example, pressures of approximately 40,000 psi may be used. The water efficiently removes materials from the surface to be cleaned.

A vacuum is also applied to the platform, and pulls the water and debris back onto the vehicle.

The water to be pumped is maintained in a fresh water tank. The water pulled back into the vehicle along with the removed material, is held in a waste water tank.

### SUMMARY OF THE INVENTION

A system for removing material from a surface includes a platform mounting a spinning water jet. A high pressure pump delivers water at a high pressure to the spin water jet. The high pressure pump receives water from a fresh water tank. A vacuum is applied within the platform to remove waste water and material back onto a vehicle frame, and into a vacuum tank. The vacuum tank is provided with filters to screen removed materials from the waste water. The waste water is returned to the fresh water tank for reuse.

These and other features of the present invention can be best understood from the following specification and drawings, the following of which is a brief description.

### BRIEF DESCRIPTION OF THE DRAWINGS

FIG. 1 schematically shows a vehicle incorporating the present invention.

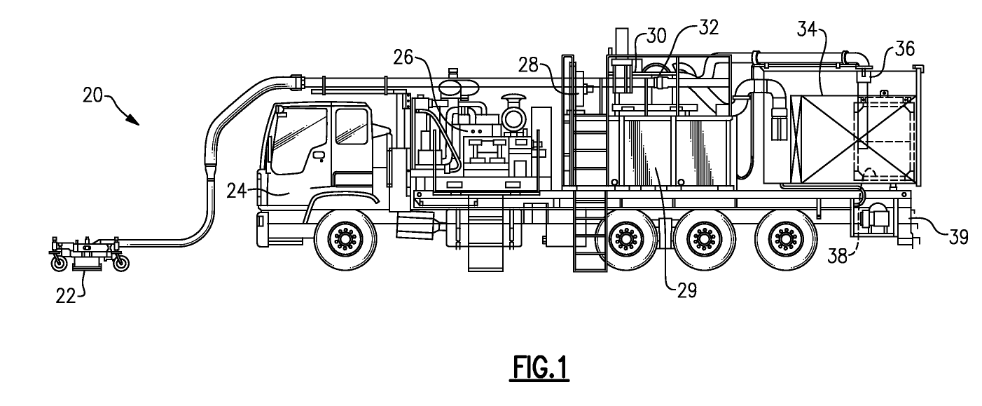

FIG. 2 is a flow diagram of the inventive system.

### DETAILED DESCRIPTION OF THE PREFERRED EMBODIMENT

As shown in the figures, a system 20 includes a platform 22 carrying a spin jet nozzle 23, which may be as known and available from NLB Corporation. The platform moves along a surface to be cleaned, such as an airport runway or a highway, and removes materials from the surface.

A cab 24, which may be a truck cab, drives the entire system 20. Platform 22 is driven to move independent of cab 24. A high pressure pump 26 delivers water to the spin jet 23, and may deliver water on the order of 40,000 psi. Other pressures, both higher and lower, may be used.

A heat exchanger 28, cartridge filter 30, vacuum power unit 32, and fresh water tank 29 are all fit onto the vehicle. In addition, filter panels 34, a vacuum tank 36, a transfer pump 39, and a debris basket 38 are all mounted on the vehicle also.

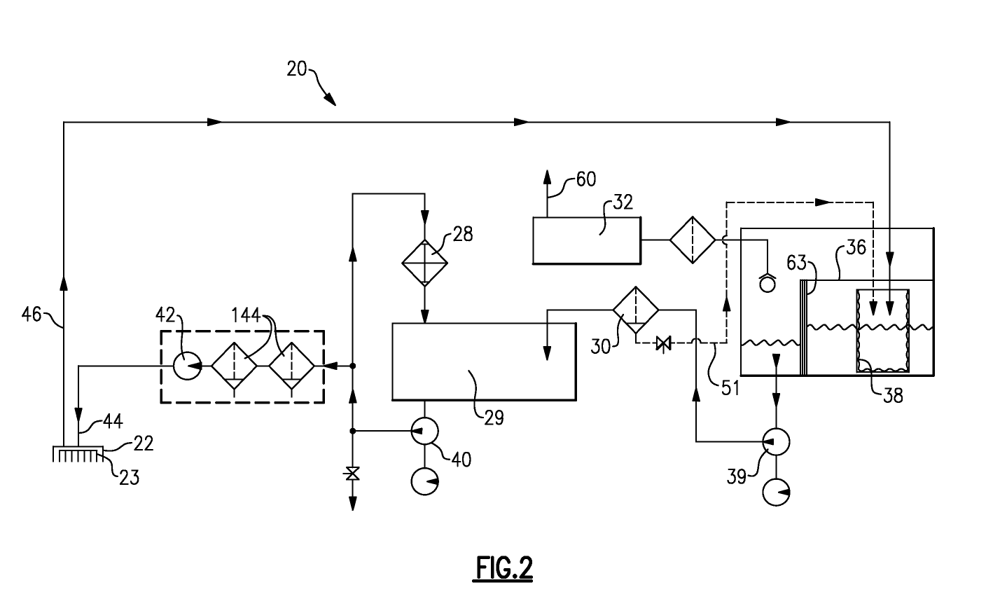

The system operates as shown best in FIG. 2. Water is delivered from pump 42 to the spin jet 23 through a high pressure water line 44. Again, this portion of the system may be similar to that available from NLB Corporation.

A vacuum line 46 pulls water and removed debris back onto the vehicle, and into a vacuum basket 36. As seen, the waste water and materials are initially delivered into a debris basket 38. The debris basket 38 allows the flow of water through the basket, and into an outer portion of the vacuum tank 36.

As shown, a vacuum is maintained on the vacuum basket by a vacuum pump 32. Vacuum pump 32 is powerful enough to pull the waste water and removed debris back into the tank from platform 22. Air is removed by the vacuum power unit 32 and delivered to atmosphere at 60.

After the waste water has moved through the debris basket, it then encounters filter panels 63. The water having passed through the filter panel 63 is still within the vacuum tank, but is now removed by a transfer pump 39 through the water filter 30. Further debris may be removed by the water filter and returned through line 51 into the debris basket 38. The debris basket 38 is formed of a suitable screen or mesh material, and have openings sized to separate the removed materials from the waste water. Downstream of the water filter 30, the water moves back into fresh water tank 29. A boost pump 40 delivers water from the fresh water tank 29 back toward the high pressure pump 42. A cartridge and bag filter combination 144 may clean the water before it reaches the pump 42. A heat exchanger 28 is also included for water being returned to the fresh water tank.

With the present invention, the time at which the system 20 may operate is increased, in that one need not refill the fresh water tank as frequently as was the case with the prior art.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A system for removing material from a surface comprising:
a platform mounting a spinning water jet;
a high pressure pump for delivering water at a high pressure to said spinning water jet, said high pressure pump connected to receive water from a fresh water tank;
a vacuum to be applied to said platform to remove waste water and to move material onto a vehicle frame, and into a vacuum tank, said vacuum tank being provided with filters to screen removed materials from the waste water, and said waste water then being returned to said fresh water tank for reuse.

2. The system as set forth in claim 1, wherein said platform is mounted forwardly of a driven vehicle, and may move independently of the driven vehicle.

3. The system as set forth in claim 1, wherein a vacuum power unit pulls a vacuum on a vacuum tank, and a vacuum line connects the vacuum tank to the platform.

4. The system as set forth in claim 3, wherein said vacuum line delivers returned water and removed debris into a debris basket, water moving through openings in the debris basket into the vacuum tank.

5. The system as set forth in claim 4, wherein water having moved through the debris basket then encounters filter panels for further removal of debris.

6. The system as set forth in claim 5, wherein water having moved through the filter panels is then moved by a transfer pump to a downstream water filter before being moved back into the fresh water tank.

7. The system as set forth in claim 6, wherein further waste may be returned from the downstream water filter back into the debris tank.

8. The system as set forth in claim 1, wherein said high pressure pump delivers water on the order of 40,000 psi.

9. A method of removing material from a surface comprising:
delivering water from a fresh water tank and at a high pressure to a spinning water jet, and against a surface to be cleaned; and
removing waste water and moving material onto a vehicle frame, and into a vacuum tank, filtering materials from the waste water, and returning said waste water to said fresh water tank for reuse.

10. The method as set forth in claim 9, wherein a vacuum power unit pulls a vacuum on a vacuum tank, and a vacuum line connecting the vacuum tank to the platform.

11. The method as set forth in claim 10, wherein said vacuum line delivering waste water and removed debris into a debris basket, water moving through openings in the debris basket into the vacuum tank.

12. The method as set forth in claim 11, wherein water having moved through the debris basket encountering filter panels for further removal of debris.

13. The method as set forth in claim 12, wherein water having moved through the filter panels is then moved by a transfer pump to a downstream water filter before being moved back into the fresh water tank.

14. The method as set forth in claim 13, wherein further waste is returned from the downstream water filter back into the debris tank.

15. The method as set forth in claim 9, wherein said high pressure is on the order of 40,000 psi.
